(19) United States
(12) Patent Application Publication
(10) Pub. No.: US 2018/0336694 A1
(43) Pub. Date: Nov. 22, 2018

(54) System and Method for Passive Tracking Based on Color Features

(71) Applicant: 4Sense, Inc., Delray Beach, FL (US)

(72) Inventor: Hai-Wen Chen, Lake Worth, FL (US)

(73) Assignee: 4Sense, Inc., Delray Beach, FL (US)

(21) Appl. No.: 15/597,941

(22) Filed: May 17, 2017

(51) Int. Cl. G06T 7/70; G01S 3/786; G01J 3/50; G06K 9/00; G06T 7/90; G06K 9/46

(52) U.S. Cl. CPC G06T 7/70; G01S 3/786; G01J 3/50; G06T 2207/30196; G06T 7/90; G06K 9/4604; G06K 9/4652; G06K 9/00771

(57) ABSTRACT

A camera for passively tracking a human is described herein. The camera can include one or more image-sensor circuits configured to generate a frame of a monitoring area. The camera can also include a processor configured track a target of the frame based on a color feature of the target. The processor can be further configured to compare a reference spectral angle to spectral angles of color pixels associated with the target and determine that the spectral angles of at least a portion of the color pixels associated with the target match the reference spectral angle based on a spectral-angle threshold of the reference spectral angle. The processor can be further configured to segment out a patch detection corresponding to the target that is defined by the color pixels with spectral angles that match the reference spectral angle based on the spectral-angle threshold.

### FIELD

The subject matter described herein relates to tracking systems and more particularly, to tracking systems that are capable of passively tracking one or more objects.

### BACKGROUND

In recent years, several companies have developed systems that detect the presence of an object and in response, take some sort of action. For example, a passive infrared (PIR) sensor that is part of a security-lighting system detects the infrared radiation (IR) emitted in its surrounding environment and may cause the lights of the system to illuminate when changes to the environment, such as movement, are detected. This type of detection is passive in nature because the object in motion is not required to take any action, other than its normal interactions within the environment being monitored, for the PIR sensor to detect it. As another example, a system may emit signals, such as laser beams, for the detection of the movement of an object, which may be used to trigger an external system. Similar to the PIR sensor example, the interaction of the object is passive because the object is unmodified as it moves through the relevant area in a normal manner. That is, the object is not required to take any predetermined actions or move in any particular manner for the motion to be detected.

These passive systems, however, are not designed to provide any information about the objects that they detect. In particular, the PIR sensor and the motion-detector system are unable to track the object as it moves through the location being monitored. Such systems also fail to detect objects that are present but remain at rest for prolonged periods and cannot distinguish from one another multiple objects that may be detected in the same area. This latter event is particularly true if an object that initiated the original detection has left the area and a new and different object has entered the area at the same time or shortly thereafter.

### SUMMARY

A camera for passively tracking a human is described herein. The camera can include a processor and an image-sensor circuit, which can be configured to generate a frame of a monitoring area. The processor can be configured to receive the frame from the image-sensor circuit and track (by a tracking process) a first target that is part of the frame based on a color feature of the first target. (The first target may be segmented out and detected by a detection process.) The processor, as part of its tracking the first target (the detection and tracking processes), can be further configured to compare a reference spectral angle to spectral angles of color pixels associated with the first target. The processor, as also part of its tracking the first target, can be configured to determine that spectral angles of at least a portion of the color pixels associated with the first target match the reference spectral angle based on a spectral-angle threshold of the reference spectral angle. The processor, also as part of its tracking the first target, can be further configured to segment out a patch detection corresponding to the first target that is defined by the color pixels with spectral angles that match the reference spectral angle based on the spectral-angle threshold.

As an example, the camera can be a red-green-blue (RGB) camera that can be configured to operate in at least three spectral bands corresponding to the colors red, green, and blue. As another example, the first target can be a human, and the color feature of the first target can be a color of an article of clothing worn by the human while in the monitoring area. The processor, also as part of its tracking the first target, may be further configured to update a position of the first target in the monitoring area, and the patch detection that is segmented out may be related to a torso of the first target.

In one arrangement, the processor can be further configured to track a second target that is part of the frame based on a color feature of the second target. As part of its tracking the first target and the second target, the processor may also be configured to perform a track-start-point (TSP) analysis on the first target and the second target. As part of the TSP analysis, the processor can be further configured to determine the second target is a new target that requires assignment of a TSP and to assign a TSP to the second target to enable its tracking of the second target to begin. The processor can be further configured to, as part of the determination that the second target is a new target, analyze positional and motion data of the second target with respect to a layout of the monitoring area. The processor can be further configured to, following the TSP analysis, initiate a color-vector-extraction process with respect to the second target to calculate a median color vector. The median color vector can include the reference spectral angle and can be determined from a median RGB value from color pixels associated with the second target.

A method for passively tracking multiple humans is also described herein. The method can include the steps of generating a first detection associated with color pixels in which the first detection can represent a first human in a monitoring area and generating a second detection associated with color pixels. The second detection can represent a second human in the monitoring area, and the second human may be in the monitoring area at the same time as the first human. The method can also include the step of distinguishing the first detection from the second detection by matching spectral angles of the color pixels associated with the first detection with a reference spectral angle originating from the first detection and matching spectral angles of the color pixels associated with the second detection with a reference spectral angle originating from the second detection. Moreover, the method can also include the step of, based on distinguishing the first detection from the second detection, simultaneously passively tracking the first human and the second human.

The method can further include the step of generating a third detection associated with color pixels. The third detection can represent a third human in the monitoring area, and the third human may be in the monitoring area at the same time as the first human and the second human. The method can also include the steps of determining the third detection is a new detection and based on determining the third detection is a new detection, assigning a track-start-point (TSP) to the third detection to enable passive tracking of the third detection to begin.

As an example, the first detection, second detection, and third detection may be part of a frame, which can also include one or more false detections. The method can further include the step of filtering the false detections as part of distinguishing the first detection from the second detection. As another example, the color pixels associated with the first detection may correspond to a color feature of the first human, and the color pixels associated with the second detection may correspond to a color feature of the second human. The method can also include the steps of producing (or realizing) a first torso-patch detection from matching the spectral angles of the color pixels associated with the first detection with the reference spectral angle of the first detection and producing a second torso-patch detection from matching the spectral angles of the color pixels associated with the second detection with the reference spectral angle of the second detection.

In one arrangement, the step of simultaneously passively tracking the first human and the second human can include (as part of a detection process) the step of determining a centroid position for the first torso-patch detection and the second torso-patch detection. As an example, the color pixels associated with the first detection and the color pixels associated with the second detection may be part of a frame produced by an RGB camera.

A method of tracking humans by a color feature is also described herein. The method can include the steps of receiving a frame of a monitoring area in which at least two humans are simultaneously located in the monitoring area and generating digital representations corresponding to the humans in the monitoring area. The method can also include the step of distinguishing the digital representations from one another based on color features associated with the humans by comparing spectral angles of color pixels of the digital representations with the reference spectral angles. Further, the method can include the step of determining positions of the humans as part of passively tracking the humans in which determining the positions of the humans may be facilitated by distinguishing the digital representations from one another.

In one embodiment, receiving the frame of the monitoring area can further include the step of receiving the frame from a camera designed to operate in a red-light spectral band, a green-light spectral band, and a blue-light spectral band. The method can further include the step of performing a track-start-point (TSP) analysis to determine whether to assign a TSP to one or more of the digital representations. As an example, the color features associated with the humans may be colors of articles of clothing worn by the humans while in the monitoring area.

### BRIEF DESCRIPTION OF THE DRAWINGS

FIG. 1 illustrates an example of a system for passively tracking one or more objects.

FIG. 2 illustrates an example of a network that includes one or more systems for passively tracking one or more objects.

FIG. 3 illustrates a block diagram of an example of a passive-tracking system for passively tracking one or more objects.

FIG. 4 illustrates an example of a composite segmented binary image.

FIG. 5 illustrates an example of an RGB frame that presents several targets.

FIG. 6 illustrates another example of the RGB frame of FIG. 5 with the targets in which a torso section of one target is visually represented.

FIG. 7 illustrates another example of a composite segmented binary image.

FIG. 8 illustrates another example of an RGB frame that presents several targets.

FIG. 9 illustrates an example of an RGB frame that presents an example of a merged detection.

FIG. 10 illustrates another example of an RGB frame that presents several targets.

FIG. 11 illustrates a flow chart that embodies an example of a process for passively tracking targets based on color features.

For purposes of simplicity and clarity of illustration, elements shown in the above figures have not necessarily been drawn to scale. For example, the dimensions of some of the elements may be exaggerated relative to other elements for clarity. Further, where considered appropriate, reference numbers may be repeated among the figures to indicate corresponding, analogous, or similar features. In addition, numerous specific details are set forth to provide a thorough understanding of the embodiments described herein. Those of ordinary skill in the art, however, will understand that the embodiments described herein may be practiced without these specific details.

### DETAILED DESCRIPTION

As previously mentioned, current detection systems are ill-suited for tracking individuals, particularly in a passive nature. A camera for passively tracking a human that overcomes the shortcomings of pre-existing systems is described herein. The camera can include one or more image-sensor circuits configured to generate a frame of a monitoring area. The camera can also include a processor configured to receive the frame from the image-sensor circuit and track a first target that may be part of the frame based on a color feature of the first target. The processor, as part of its tracking the first target can be further configured to compare a reference spectral angle to spectral angles of color pixels associated with the first target and determine that the spectral angles of at least a portion of the color pixels associated with the first target match the reference spectral angle based on one or more spectral-angle thresholds of the reference spectral angle. The processor, as also part of its tracking the first target, can be further configured to segment out a patch detection corresponding to the first target that can be defined by the color pixels with spectral angles that match the reference spectral angle based on the spectral-angle threshold.

As an example, such a camera can differentiate between humans based on the colors of articles of clothing worn by the humans. Because these articles are typically worn by humans for extended periods of time, this solution can enable passive tracking of the humans over the course of a certain interval, such as a workday. Moreover, relying on a reference spectral angle can ensure robust tracking because humans rarely wear identical articles of clothing.

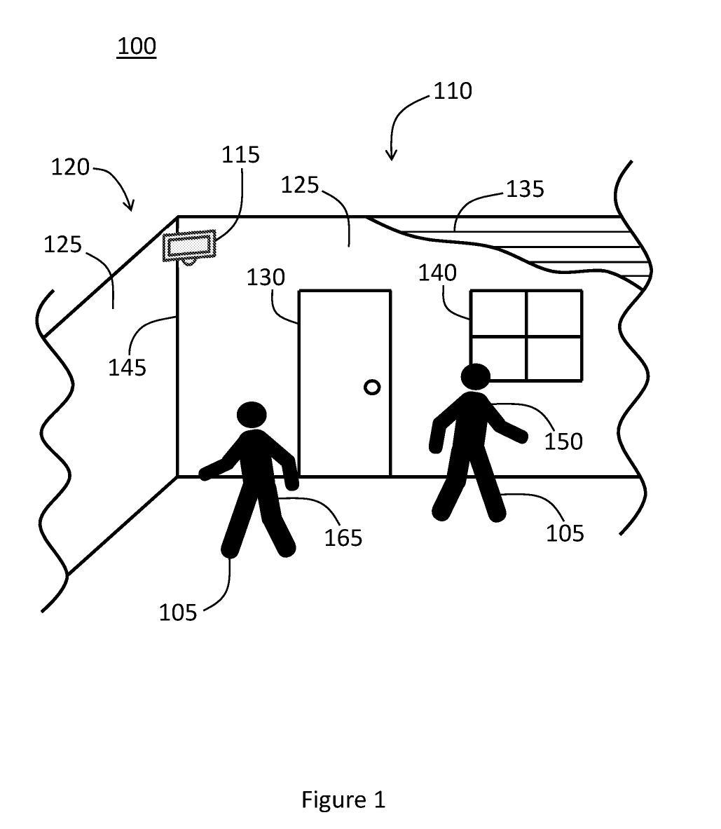

Detailed embodiments are disclosed herein; however, it is to be understood that the disclosed embodiments are intended only as exemplary. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-11, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. Those of skill in the art, however, will understand that the embodiments described herein can be practiced without these specific details.

Several definitions that are applicable here will now be presented. The term “sensor” is defined as a component or a group of components that include at least some circuitry and are sensitive to one or more stimuli that are capable of being generated by or originating or reflected from a living being, composition, machine, etc. or are otherwise sensitive to variations in one or more phenomena associated with such living being, composition, machine, etc. and provide some signal or output that is proportional or related to the stimuli or the variations. An “image-sensor circuit” is defined as a sensor that receives and is sensitive to at least visible light and generates signals for creating images, or frames, based off the received visible light. An “object” is defined as any real-world, physical object or one or more phenomena that results from or exists because of the physical object, which may or may not have mass. An example of an object with no mass is a human shadow. A “target” is defined as an object or a representation of an object that is being or is intended to be passively tracked. The term “monitoring area” is an area or portion of an area, whether indoors, outdoors, or both, that is the actual or intended target of observation or monitoring for one or more sensors.

A “frame” (or “image”) is defined as a set or collection of data that is produced or provided by one or more sensors or other components. As an example, a frame may be part of a series of successive frames that are separate and discrete transmissions of such data in accordance with a predetermined frame rate. A “reference frame” is defined as a frame that serves as a basis for comparison to another frame. A “visible-light frame” is defined as a frame that at least includes data that is associated with the interaction of visible light with an object or the presence of visible light in a monitoring area or other location.

A “processor” is defined as a circuit-based component or group of circuit-based components that are configured to execute instructions or are programmed with instructions for execution (or both) to carry out the processes described herein, and examples include single and multi-core processors and co-processors. The term “circuit-based memory element” is defined as a memory structure that includes at least some circuitry (possibly along with supporting software or file systems for operation) and is configured to store data, whether temporarily or persistently. A “communication circuit” is defined as a circuit that is configured to support or facilitate the transmission of data from one component to another through one or more media, the receipt of data by one component from another through one or more media, or both. As an example, a communication circuit may support or facilitate wired or wireless communications or a combination of both, in accordance with any number and type of communications protocols.

A “camera” is defined as an instrument for capturing images and operates in the visible-light spectrum, the non-visible-light spectrum, or both. A “red-green-blue camera” or an “RGB camera” is defined as a camera whose operation is based on the principle of the visible red-blue-green (RGB) color spectrum in which red, green, and blue light are added together in various ways to form a broad array of colors. A “pixel” is defined as the smallest addressable element in an image. A “color pixel” is defined as a pixel based on a combination of one or more colors. A “detection” is defined as a representation of an object and is attached with or includes data related to one or more characteristics of the object. A detection may exist in digital or visual form (or both). A “full-body detection” is a detection that represents an object in its entirety or its intended entirety. A “patch detection” is defined as a detection that represents a portion of an object and is realized from color-based matching. A “false detection” is defined as a detection that does not correspond to a target or is not intended to be tracked.

The term “communicatively coupled” is defined as a state in which signals may be exchanged between or among different circuit-based components, either on a uni-directional or bi-directional basis, and includes direct or indirect connections, including wired or wireless connections. A “hub” is defined as a circuit-based component in a network that is configured to exchange data with one or more passive-tracking systems or other nodes or components that are part of the network and is responsible for performing some centralized processing or analytical functions with respect to the data received from the passive-tracking systems or other nodes or components.

The term “digital representation” is defined as a representation of an object in which the representation is in digital form or otherwise is capable of being processed by a computer. A “human-recognition feature” is defined as a feature, parameter, or value that is indicative or suggestive of a human or some portion of a human. Similarly, a “living-being-recognition feature” is defined as a feature, parameter, or value that is indicative or suggestive of a living being or some portion of a living being.

The term “three-dimensional position” is defined as data that provides in three dimensions the position of an element in some setting, including real-world settings or computerized settings. The term “two-dimensional position” is defined as data that provides in two dimensions the position of an element in some setting, including real-world settings or computerized settings. The term “periodically” is defined as recurring at regular or irregular intervals or a combination of both regular and irregular intervals. The term “confidence factor” is defined as one or more values or other parameters that are attached or assigned to data related to a measurement, calculation, analysis, determination, finding, or conclusion and that provide an indication as to the likelihood, whether estimated or verified, that such data is accurate or plausible.

The term “color vector” is defined as a vector whose direction is determined by the color of the object with which the vector is associated, such as by a color pixel corresponding to the object. The term “reference spectral angle” is defined as a spectral angle based on a collective RGB value of the pixels associated with a detection against which the spectral angles of other pixels are compared. The term “color feature” is defined as a value, characteristic, or parameter that defines or is related to the color of an object or some article attached to, worn by, or otherwise associated with the object. The word “match” is defined as to equal or be equivalent to a predetermined value or one or more of a predetermined values in a range of values. The term “track-start-point” is a position that defines the starting point of a track or the tracking of a detection or target.

The word “generate” or “generating” is defined as to bring into existence or otherwise cause to be. The word “distinguish” or “distinguishing” is defined as to recognize as distinct or different or to set apart or identify as distinct or different.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g. AB, AC, BC or ABC). Additional definitions may be provided throughout this description.

Referring to FIG. 1, an example of a system 100 for tracking one or more objects 105 in a monitoring area 110 is shown. In one arrangement, the system 100 may include one or more passive-tracking systems 115, which may be configured to passively track any number of the objects 105. The term “passive-tracking system” is defined as a system that is capable of passively tracking an object. The term “passively track” or “passively tracking” is defined as a process in which a position of an object, over some time, is monitored, observed, recorded, traced, extrapolated, followed, plotted, or otherwise provided (whether the object moves or is stationary) without at least the object being required to carry, support, or use a device capable of exchanging signals with another device that are used to assist in determining the object's position.

In some cases, an object that is passively tracked may not be required to take any active step or non-natural action to enable the position of the object to be determined. Examples of such active steps or non-natural actions include the object performing gestures, providing biometric samples, or voicing or broadcasting certain predetermined audible commands or responses. In this manner, an object may be tracked without the object acting outside its ordinary course of action for a particular environment or setting. An object that is being passively tracked, has been designated to be passively tracked, or is intended to be passively tracked may be referred to as a candidate object, target, or tracking target.

In one case, the object 105 may be a living being. Examples of living beings include humans and animals (such as pets, service animals, animals that are part of an exhibition, etc.). Although plants are not capable of movement on their own, a plant may be a living being that is tracked or monitored by the system described herein, particularly if they have some significant value and may be vulnerable to theft or vandalism. An object 105 may also be a non-living entity, such as a machine or a physical structure, like a wall or ceiling. As another example, the object 105 may be a phenomenon that is generated by or otherwise exists because of a living being or a non-living entity, such as a shadow, disturbance in a medium (e.g., a wave, ripple or wake in a liquid), vapor, or emitted energy (like heat or light).

The monitoring area 110 may be an enclosed or partially enclosed space, an open setting, or any combination thereof. Examples include man-made structures, like a room, hallway, vehicle or other form of mechanized transportation, porch, open court, roof, pool or other artificial structure for holding water of some other liquid, holding cells, or greenhouses. Examples also include natural settings, like a field, natural bodies of water, nature or animal preserves, forests, hills or mountains, or caves. Examples also include combinations of both man-made structures and natural elements.

In the example here, the monitoring area 110 is an enclosed room 120 (shown in cut-away form) that has a number of walls 125, an entrance 130, a ceiling 135 (also shown in cut-away form), and one or more windows 140, which may permit natural light to enter the room 120. Although coined as an entryway, the entrance 130 may be an exit or some other means of ingress and/or egress for the room 120. In one embodiment, the entrance 130 may provide access (directly or indirectly) to another monitoring area 110, such as an adjoining room or one connected by a hallway. In such a case, the entrance 130 may also be referred to as a portal, particularly for a logical mapping scheme. In another embodiment, the passive-tracking system 115 may be positioned in a corner 145 of the room 120 or in any other suitable location. These parts of the room 120 may also be considered objects 105. As will be explained below, the passive-tracking system 115 may be configured to passively track any number of objects 105, such as humans 150 and 165, in the room 120, including both stationary and moving objects 105.

As an example, a passive-tracking system 115 may be assigned to a particular monitoring area 110, meaning that it may passively track objects 105 within the monitoring area 110 or both within and proximate to the monitoring area 110. The passive-tracking system 115, however, may passively track objects 105 outside its assigned monitoring area 110, including objects 105 that are an extended distance from the assigned area 110. Moreover, more than one passive-tracking system 115 may be assigned to a monitoring area 115, and a passive-tracking system 115 may not necessarily be assigned to monitor a particular area, as passive tracking could be performed for any particular setting in accordance with any number of suitable parameters.

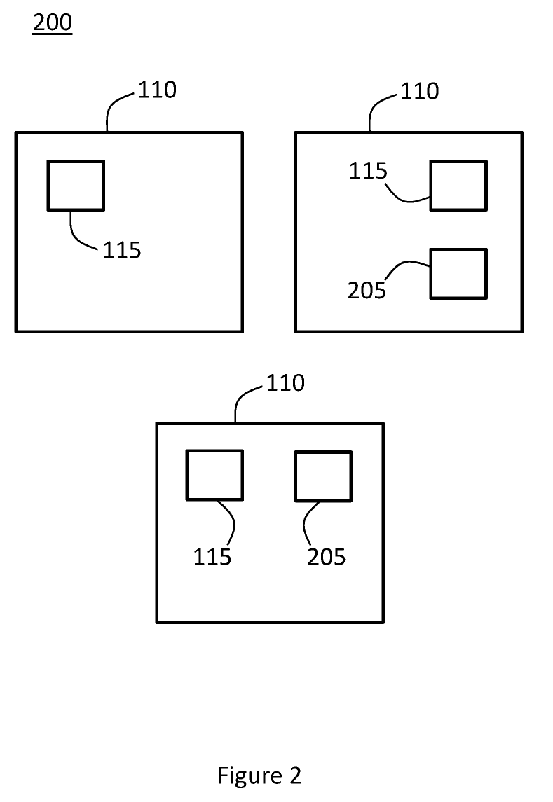

Turning to FIG. 2, an example of a network 200 is shown. In this example, the network 200 may include a plurality of passive-tracking systems 115, each of which may be configured to passively track objects 105 in a monitoring area 110. As such, each passive-tracking system 115 may be responsible for passively tracking objects 105 in a monitoring area 110 that has been assigned to it. As another example, more than one passive-tracking system 115 may be assigned to a particular monitoring area 110, while others may not necessarily be assigned to any monitoring area 110. Moreover, the passive-tracking systems 115 may be fixed in place in or proximate to a monitoring area 110, although the passive-tracking systems 115 are not necessarily limited to such an arrangement. For example, one or more passive-tracking systems 115 may be configured to move along a track or some other structure that supports movement or may be attached to or integrated with a machine capable of motion, like a drone, vehicle, or robot.

The network 200 may also include one or more hubs 205, which may be communicatively coupled to any of the passive-tracking systems 115. The hubs 205 may process data received from the passive-tracking systems 115 and may provide the results of such processing to the systems 115. In addition, any number of the passive-tracking systems 115 may be communicatively coupled to any of the other passive-tracking systems 115. As such, any combination of the passive-tracking systems 115 and the hubs 205 may exchange various types of data between or among each other. To support this data exchange, the passive-tracking systems 115 and the hubs 205 may be built to support wired or wireless (or both) communications in accordance with any acceptable standards. The hubs 205 may be positioned within any monitoring area 110 or outside the monitoring areas 110 (or a combination of both). As such, the hubs 205 may be considered local or remote, in terms of location and being hosted, for a network 200.

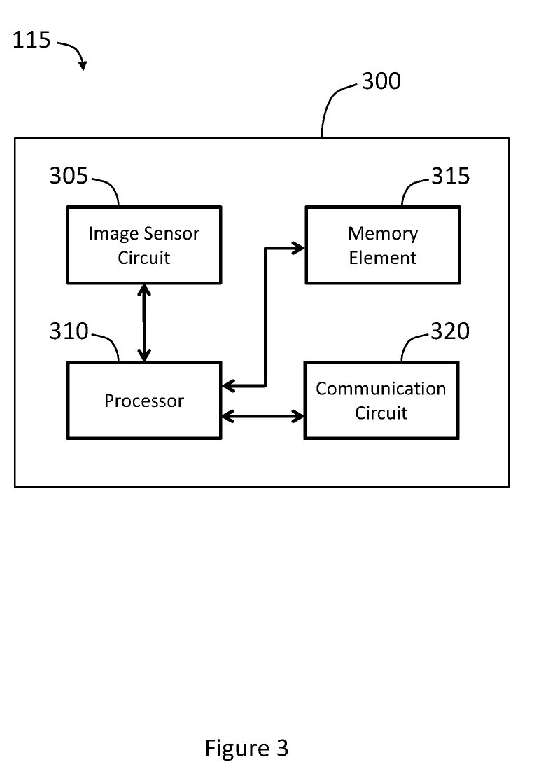

Referring to FIG. 3, a block diagram of an example of a passive-tracking system 115 is shown. In this embodiment, the passive-tracking system 115 can be a camera 300, which can include one or more image-sensor circuits 305, one or more processors 310, one or more circuit-based memory elements 315, and one or more communication circuits 320. Each of the foregoing devices of the camera 300 can be communicatively coupled to the processor 310 and to each other, where necessary. Although not pictured here, the camera 300 may also include other components to facilitate its operation, like power supplies (portable or fixed), heat sinks, displays or other visual indicators (like LEDs), speakers, and supporting circuitry. The description herein that references a passive-tracking system 115 also applies to the camera 300. For example, the camera 300 may be positioned in a monitoring area 110 to passively track objects 105, as previously explained in terms of the passive-tracking system 115.

The image-sensor circuit 305 can be any suitable component for receiving light and converting it into electrical signals for the purpose of generating images (or frames). Examples include a charge-coupled device (CCD), complementary metal-oxide semiconductor (CMOS), or N-type metal-oxide semiconductor (NMOS).

The processor 310 can oversee the operation of the camera 300 and can coordinate processes between all or any number of the components of the camera 300. Any suitable architecture or design may be used for the processor 310. For example, the processor 310 may be implemented with one or more general-purpose and/or one or more special-purpose processors, either of which may include single-core or multi-core architectures. Examples of suitable processors include microprocessors, microcontrollers, digital signal processors (DSP), and other circuitry that can execute software or cause it to be executed (or any combination of the foregoing). Further examples of suitable processors include, but are not limited to, a central processing unit (CPU), an array processor, a vector processor, a field-programmable gate array (FPGA), a programmable logic array (PLA), an application specific integrated circuit (ASIC), and programmable logic circuitry. The processor 310 can include at least one hardware circuit (e.g., an integrated circuit) configured to carry out instructions contained in program code.

In arrangements in which there is a plurality of processors 310, such processors 310 can work independently from each other or one or more processors 310 can work in combination with each other. In one or more arrangements, the processor 310 can be a main processor of some other device, of which the camera 300 may or may not be a part. This description about processors may apply to any other processor that may be part of any system or component described herein, including any of the individual components of the camera 300.

The circuit-based memory elements 315 can be include any number of units and type of memory for storing data. As an example, a circuit-based memory element 315 may store instructions and other programs to enable any component, device, sensor, or system of the camera 300 to perform its functions. As an example, a circuit-based memory element 315 can include volatile and/or non-volatile memory. Examples of suitable data stores here include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. A circuit-based memory element 315 can be part of the processor 310 or can be communicatively connected to the processor 310 (and any other suitable devices) for use thereby. In addition, any of the various other parts of the camera 300 may include one or more circuit-based memory elements 315.

In one arrangement, the camera 300 may be a red-green-blue (RGB) camera, meaning that it has several bandpass filters configured to permit light with wavelengths that correspond to these colors to pass through to the image-sensor circuit 305. In a typical RGB camera, the wavelength associated with the peak value for blue is around 430 nanometers (nm), green is about 550 nm, and red is roughly 620 nm. Of course, these wavelengths, referred to as central wavelengths, may be different for some RGB cameras, and the processes described herein may be performed irrespective of their values. In addition, the RGB camera may be configured with additional bandpass filters to allow light in other spectral bands to pass, including light within and outside the visible spectrum. For example, the RGB camera may be equipped with a near infra-red bandpass filter (NIR) to enable light in that part of the spectrum to reach the image-sensor circuit 305. As an example, the NIR wavelength associated with peak value may be around 850 nm, although other wavelengths may be used.

In some cases, adjustments can be made after the initial setting of the central wavelengths. For example, the central wavelength for red may be moved from 620 nm to 650 nm, such as by placing an additional filter over the existing bandpass filter or re-programming it. In fact, the RGB camera may be reconfigured to block out light in any of the existing RGB spectral bands and may continue to provide useful data as long as at least two spectral bands remain. In addition, the camera 300 is not necessarily limited to an RGB camera, as the camera 300 may employ any number and combination of spectral bands for its operation. As the number of spectral bands increases, the ability of the camera 300 to distinguish objects 105 from one another improves, although a balance should be maintained because the processing of the additional information increases the computational complexity of the camera 300, particularly if moving targets are to be tracked.

No matter the configuration of the camera 300, the processor 310 may acquire spectral-band values from the input of the image-sensor circuit 305 that are based on the light received by the image-sensor circuit 305. The processor 310 may acquire these values by generating or determining them itself (based on the incoming signals from the image-sensor circuit 305) or receiving them directly from the image-sensor circuit 305. For example, in the case of an RGB camera, the image-sensor circuit 305 may provide the processor 310 with three RGB values for each pixel. The collection of the RGB values for the pixels may be part of an image, or frame, that represents the subject matter captured by the image-sensor circuit 305, and additional operations may be performed on this image later, as will be explained below.

As mentioned previously, the camera 300 may be positioned in a monitoring area 110. The camera 300 may generate one or more frames, such as RGB frames, that include data associated with the monitoring area 110, and these frames may be set as reference frames, to which other frames may be compared. For example, in an initial phase of operation, the camera 300 may capture images of the room 120 and can generate the frames, which may contain data about the layout of the room 120 and certain objects 105 in the room 120 that are present during this process. Some of the objects 105 may be permanent fixtures of the room 120, such as the walls 125, entrance 130, ceiling 135, and windows 140. As such, these initial frames can be set as reference frames and can be stored in, for example, the circuit-based memory element 315 or some other database for later retrieval.

Because these objects 105 may be considered permanent or recognized fixtures of the room 120, as an option, a decision can be made that passively tracking such objects 105 is unnecessary or not helpful. Other objects 105, not just permanent or recognized fixtures of the room 120, may also be ignored for purposes of passively tracking. Through this initial phase, the camera 300 may also map the layout of the monitoring area 110 (e.g., room 120), which can be used later to make assumptions or predictions about objects 105 that are being (or are about to be) tracked. As an example, the layout may enable the camera 300 to identify points of ingress/egress (like the entrance 130) and other structures that may facilitate or impede movement by a human in the monitoring area 110.

Ignoring insignificant objects 105, which may represent static background clutter, may narrow the focus of the passive-tracking process. For example, assume one or more reference frames include data associated with one or more objects 105 that are not to be passively tracked. When the camera 300 generates a current frame and forwards it to the processor 310, the processor 310 may compare the current frame to the reference frame. As part of this comparison, the processor 310 can subtract out the objects 105 in the current frame that are substantially the same size and are in substantially the same position as the objects 105 of the reference frame. The processor 310 can then focus on new or unidentified objects 105 in the current frame that do not appear as part of the reference frame, and they may be suitable candidates for passive tracking. These objects 105 may also be referred to as candidate objects 105 or targets. Although this filtering process may remove significant portions of background clutter, the current frame, as will be described below, may still produce multiple false detections. Solutions for overcoming the false detections will also be presented below.

As another option, when a current frame is received, the current frame can be set as a reference frame. The previous frame that was received can then be subtracted from the reference (current) frame to obtain a current frame with suppressed background clutter. As this step can suppress static background clutter, it can help remove insignificant objects 105 from the current frame.

Following the removal of the background clutter, a current RGB frame may include the RGB values related to several detections, some of which may correspond to the targets. Other detections, however, may not be related to the targets, and these detections may be referred to as false detections. Because this description focuses primarily on passively tracking humans (but is not so limited), a target may also be referred to as a human, human target, or tracking target, although a target is not necessarily limited to a human. These RGB values may be normalized values. This data may be set aside for later retrieval and comparative analysis, as will be explained below. A detection process may be performed with respect to the detections. Because this detection process focuses on the detections in their entireties, these detections may be referred to as full-body detections. Some of the full-body detections may correspond to the targets in a monitoring area 110, but other full-body detections may result from false detections.

In one embodiment, to enable the detection process, the processor 310 may convert the RGB frame into a binary image. To do so, the processor 310 may initially transform the RGB frame into the hue-saturation-value (HSV) domain, thereby creating a hue (H) image, a saturation (S) image, and a value (V) image. Following the transformation, the processor 310 may focus on the S and V images and can throw out or ignore the H image. As will be explained below, binary images may be segmented out from the S and V images, based on certain values.

In one embodiment, the V image, which may relate to brightness, may be approximated by an exponential probability-density function (PDF) with a median value and right and left tails and the S image by a one-side tail Rayleigh PDF with a median value. Pixels of the V image with values that are to the left of the median value (i.e., left-tail values) are associated with dim-intensity objects, like black clothing or dark-brown hair. Conversely, pixels of the V image with values that are to the right of the median value (i.e., right-tail values) correspond to bright-intensity objects, such as a white shirt. Those pixels with pronounced values on either side of the median value, because they may be pixels related to the full-body detections, may be assigned a binary one. Conversely, those pixels with lower values on either side may be considered background pixels and may be assigned a binary zero. These pixels may be associated with background clutter. A constant threshold may be set for both the left and right sides of the median value of the V image to identify cutoff values for determining whether a pixel should be assigned a binary one or zero. As such, a segmented binary image may originate from the V image based on both the left and right tails of the V image.

A similar process may be realized from the S image, although a single tail may be involved for this image. In particular, pixels with pronounced S values that are above a constant threshold may be associated with higher saturation values and, hence, a full-body detection and may be assigned binary ones. The pixels of the S image with values below the constant threshold may be assigned a binary zero, meaning they may be associated with background clutter.

Once the segmented binary images are realized for the V and S images, a logical OR operation may be applied to the two images to form a new composite segmented binary image, which may also be referred to as a full-body segmentation image. The composite segmented binary image may be composed of pixels with binary-one or binary-zero values, with, for example, the binary-one values realized from either the V or S image. A binary-one value may also be referred to as a high or positive value, and a binary-zero value may also be referred to as a low value. As such, the composite segmented binary image, when displayed, may provide a visual representation of one or more full-body detections in a binary environment.

The use of constant thresholds in this segmentation process, however, may cause deviations in the analysis because illumination may vary over time, and the readings associated with a target may shift as the distance between the target and the camera 300 changes. These effects may cause over-thresholding in which separate full-body detections represented in the composite segmented binary image merge together or under-thresholding in which a full-body detection is broken into several smaller pieces. Moreover, false detections may also be represented in the composite binary image.

To address these problems, the processor 310 may conduct morphological filtering on the composite segmentation binary image. As an example, the morphological filtering can include the operations of dilation, erosion, and opening. Structuring elements can be defined for these operations. For example, the structuring elements can be vertical vectors with certain pixel dimensions, such as 9×1 for the vertical vector for the erosion and opening steps and 30×1 for the vertical vector for the dilation operation. In this example, the erosion and opening operations, which may be collectively referred to as a scissors operation, may be applied to the full-body detections that are part of this image. As an example, full-body detections in the binary image with a height in the Y-direction of less than nine pixels may be cut from the image, including (as an option) those that may be connected to another full-body detection in the image. Removing these smaller full-body detections from the image may reduce the affects from false detections. Next, for the dilation step, vertical gaps less than 30 pixels in length can be bridged, which typically joins smaller full-body detections with larger full-body detections, a separation that may have been due to under-thresholding. Additional steps may be taken to reduce the impact of false detections, such as by analyzing data related to the detections that was acquired from previous frames. Some examples of this solution will be presented later in another context.

As an option, certain values or thresholds may be adjusted for the morphological filtering. For example, the pixel dimensions of the vertical vectors associated with the dilation, erosion, and opening operations may be changed. In addition, the constant thresholds for the V and S images may be modified, and if necessary, adaptive thresholds may be employed to account for the motion of the targets, particularly in the case of movement closer to the camera 300. Additional information on morphological filtering and other related concepts can be found in, for example, “Moving Human Full-Body and Body-Parts Detection, Tracking, and Applications on Human Activity Estimation, Walking Pattern and Face Recognition,” Hai-Wen Chen and Mike McGurr, Proc. of SPIE, Vol. 9844, 98440T, May 2016, which is incorporated herein by reference.

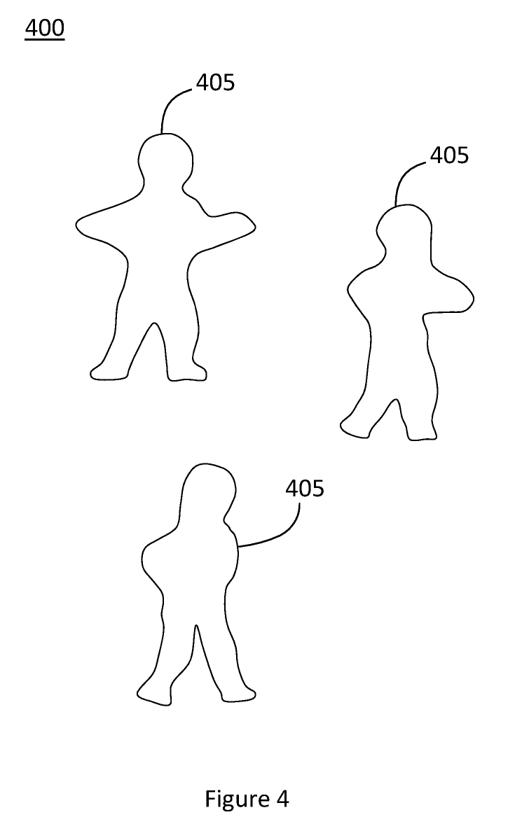

Referring to FIG. 4, an example of a composite segmented binary image 400 corresponding to the original RGB frame is shown. The composite segmented binary image 400 includes visual representations of three full-body detections 405 (in binary form), following the morphological filtering steps. The full-body detections 405 in this case correspond to targets for tracking. In this visual environment, the pixels that make up the full-body detections 405 have a binary value of one, which enables them to be segmented out, and those that are not part of the full-body detections 405 have a binary value of zero. In one embodiment, the processor 310 may execute a detection process with respect to the composite segmented binary image 400 in which the processor 310 generates one or more detection fields. The detection fields can define certain values or parameters, which may be based on the grouping of pixels that define each full-body detection 405. Additionally, the detection fields may be part of a data structure attached to or part of a full-body detection, and the data structure can be referred to as detection data. Although the description here focuses on full-body detections related to human targets, detection data may (in some cases) be generated for full-body detections that are unrelated to human targets, including those from false detections

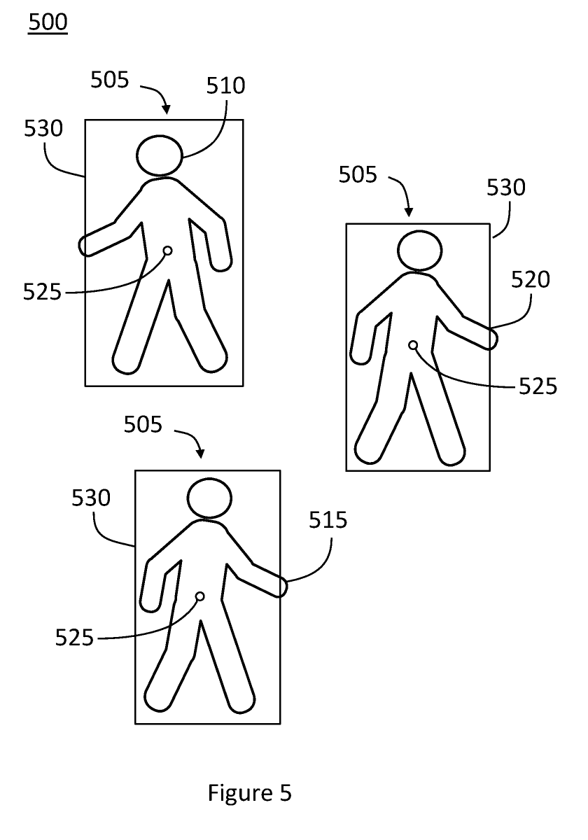

Referring to FIG. 5, an example of an RGB frame 500 that shows several targets 505 (in visual-representation form) is presented. As referenced earlier, these targets 505 may lead to full-body detections. As such, use of the term “target” may be equivalent to the term “full-body detection,” where applicable. The RGB frame 500 may be a current frame from which the composite segmented binary image 400 described above was realized, and the targets 505 may correspond to humans in the monitoring area 110. In this example, the targets 505 also correspond to the full-body detections 405 represented in the composite segmented binary image 400 of FIG. 4. The RGB frame 500 illustrated here is intended to provide a visual realm to assist in the explanation of the systems and processes described herein and how they may be useful in passively tracking the targets. As part of this explanation, the targets 505 may be individually referred to as a target 510, target 515, and target 520, and detection data may be realized for each of them.

Examples of some of the detection fields of the detection data are shown in visual form in reference to the targets 505. In particular, in relation to each target 505 and based on the composite segmented binary image 400, the processor 310 may estimate the X and Y positions of a centroid 525 and X and Y positions for the four corners of a bounding box 530. The X and Y positions of the centroid 525 may be used to establish the position of the corresponding target 505 in the monitoring area 110. The processor 310 may also determine an X span and a Y span for the targets 505. The X span may provide the number of pixels spanning across the horizontal portion of a target 505, and the Y span may do the same for the vertical portion of the target 505.

Additional data points may be calculated for the targets 505 based on the composite segmented binary image 400. For example, the processor 310 may estimate a size, height-to-width (HWR) ratio (or length-to-width (LWR) ratio), and deviation from a rectangular shape for the targets 505. (These estimates may be based on the number of pixels related to the full-body detections 405.) The deviation from a rectangular shape can provide an indication as to how much the grouping of pixels deviates from a rectangular shape. The detection fields may also include the X and Y positioning of pixels associated with the target 505. As an example, the X and Y positioning of all the pixels associated with the target 505 (i.e., the entire full-body detection) may be part of the detection data. As an option, the X and Y positioning of one or more subsets of pixels of all the pixels associated with the target 505 may be part of the detection data.

The detection data may include other data in addition to the detection fields, and the number and type of detection fields are not necessarily limited to the examples shown here. For example, one or more track fields may be calculated and may be part of the detection data. This data may be related to a track for a full-body detection, which may indicate the movement of a target 505, and can be obtained from an analysis of one or more previous frames. Examples of track fields include the change in the X and Y positions of the centroid 525, the velocity of the target 505, the number of the current frame of the track, and the predicted X and Y positions of the centroid 525 in the next frame. The detection data is not necessarily limited to the number and type of track fields recited here.

Detection data may be determined for and associated with each of the targets 505, and the detection data can facilitate the passive tracking of the targets 505. Nonetheless, as the targets 505 may represent three different humans, passively tracking the different targets 505 presents several difficult obstacles to overcome. In particular, the processor 310 should be able to track each of the three targets 505 across multiple frames, even if the targets 505 move in different directions and at different speeds or commingle, while stationary or in motion. As part of such tracking, the processor 310 may be required to determine whether to assign a starting point for a track of a target 505. To enable this determination, the processor 310 may initiate a track-start-point (TSP) analysis following the detection process.

To provide an illustration of the TSP analysis, consider the following example. The targets 510, 515 may have already been present in the monitoring area 110 when the RGB frame 500 was created, and the target 520 may have just been detected in the monitoring area 110. This detection may result from the target 520 recently entering the monitoring area 110. As part of the TSP analysis, the processor 310 may compare several values of the detection data of the targets 505 with the layout of the monitoring area 110 or other frames previously received (or both) to determine whether a TSP should be assigned to designate the beginning of a track of one or more of the targets 505 with respect to the (current) RGB frame 500. As an option, this analysis may also involve recording such values and comparing them to data associated with frames that are received in the near future, such as a predetermined number of frames to be generated after the current frame.

As an example, the current position and motion of the targets 510, 515, which can be obtained from the detection and track fields of the related detection data, may indicate the targets 510, 515 are positioned a significant distance from an entrance and are moving in a direction towards such entrance, possibly indicating an exit. Based on these readings, the processor 310 may determine the tracking for the targets 510, 515 is already in progress and TSPs have been previously assigned to their tracks. As an example, a track of a target may be a series of discrete positions of the detection over time that reflects the movement (if any) of the target 505 over that time. In contrast to the targets 510, 515, the target 520 may be positioned near the entrance and may be moving away from the entrance, meaning the target 520 likely entered the monitoring area 110 recently. In this case, a TSP may be assigned to a track associated with the target 520, and the TSP can represent the starting point for the tracking of this target 520. A target 505 that requires a TSP to begin its tracking may be referred to as a new target 505 (or a new full-body detection). In one example, the number of the current frame of the track can be set to a value of one (or zero) to indicate this frame is the start of the track for the new target 505.

As an option, the position/motion analysis of the targets 505 may be conducted in reference to one or more previous frames. In addition, several more frames may be received and reviewed before completing the analysis. This additional information may enable the processor 310 more accurately determine whether to assign a TSP for a target 505. The generation of detection data and the position/motion analysis may apply to any full-body detection, including those that are not related to a target 505. Moreover, parameters other than position or motion may be considered for the TSP analysis, and as an option, weights may be assigned to the different parameters to adjust accuracy. The determinations made here with respect to TSPs may also be rooted in probabilities, with their comparisons to TSP thresholds executed for determining whether a TSP should be assigned. The TSP thresholds for making these decisions may be adjusted to improve system quality.

A TSP analysis can be performed on each frame or periodically, such as on every n^{th} frame, where “n” can be any positive, non-zero integer. The TSP analysis is not typically computationally intensive. As such, the occurrence of its processes may be adjusted as necessary. For example, in a monitoring area 110 that is small in size, the periodicity of the TSP analysis may be reduced.

Following the TSP analysis, the processor 310 may conduct a color-vector-extraction process, which may focus on the targets 505 that recently had their TSPs assigned. In the example above, recall that the TSP analysis resulted in the target 520 being assigned a TSP.

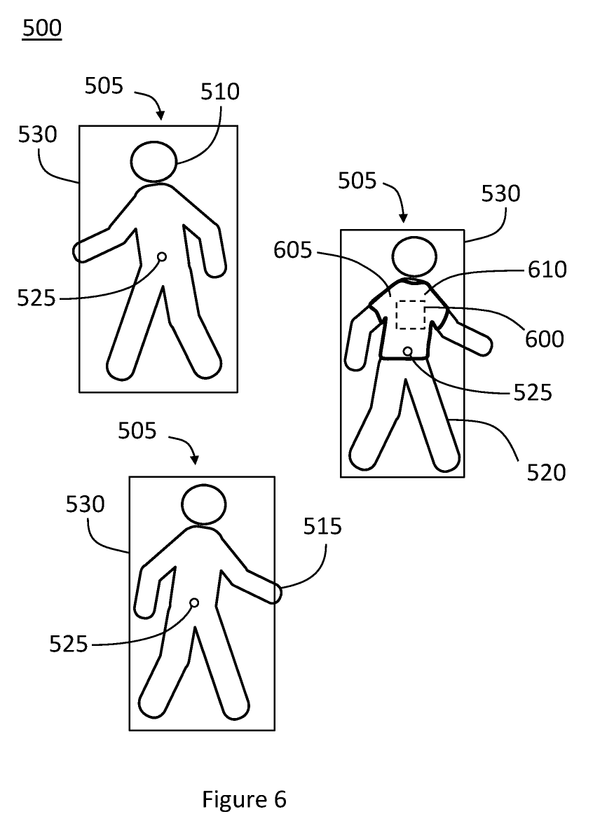

Referring to FIG. 6, the RGB frame 500 with the three targets 510, 515, 520 is shown again. In one embodiment, RGB pixel values may be extracted for the new targets 505, which in this case is the target 520. Because the targets 510, 515 already had their TSPs assigned (prior to the current TSP analysis), this current cycle of the color-vector-extraction process may not apply to them. As part of the color-vector-extraction process, because the detection data of the target 520 may include the X and Y positioning of the pixels related to the target 520, the processor 310 may use a portion of the positioning data as a mask and conduct a logical AND operation between the portion of the positioning data and the original RGB frame, or RGB frame 500. From this operation, RGB values related to the pixels may be extracted. (The RGB values may correspond to color vectors.) The processor 310 may estimate a reference color vector from the extracted RGB pixel values, which may be normalized, for the target 520. In this case, the reference color vector may be a preliminary reference color vector.

For example, the pixels that serve as the basis for the extraction of the RGB values here may be related to a certain area of a target 505. In one arrangement, this subset of pixels may be identified by reference to one or more detection fields of the detection data. For example, the processor 310 may designate pixels for the extraction based on their relation to the centroid 525 and the X and Y spans. In this example, the designated pixels may be situated above the centroid 525 and within certain ranges of the X and Y spans such that the pixels define an approximate torso area of the target 505. The torso area is represented by a torso section 600 (with dashed boundaries) for the target 520, as shown in FIG. 6. To be clear, a torso or torso area may be defined by the front of a target only (i.e., equivalent to the chest and abdomen of the target), the back of a target only (i.e., equivalent to the back of the target), or both the front and back of a target.

From the extracted RGB values, the processor 310 may determine a median RGB value, from which the preliminary reference color vector may be generated. The preliminary reference color vector may have a direction and a length, and the direction may define a preliminary reference spectral angle. In view of this arrangement, the preliminary reference color vector may be related to the color(s) of the torso of the target 520. (Because the preliminary reference color vector is realized from a median RGB value, the preliminary reference color vector may be related to a single color or multiple colors.) Although the extraction of the RGB pixel values is described at this stage, it may occur earlier, such as during the initial detection process presented above. Moreover, as an option, the X and Y positioning of different subsets of pixels associated with other portions of a target 505 may be used for the color-vector extraction.

In one embodiment, the processor 310 may be configured with a spectral angle mapper (SAM) solution. The SAM solution can be used to determine the spectral similarity between two spectra by calculating the angle between the spectra and treating them as vectors in a space with dimensionality equal to the number of spectral bands. The spectral angle between similar spectra is small, meaning the wavelengths of the spectra and, hence, the color associated with them are alike. Thus, a reference spectral angle, like the preliminary reference spectral angle, may be useful for segmenting out a portion, or patch, of a full-body detection in terms of color similarity among the pixels associated with the full-body detection.

Once the preliminary reference color vector is generated, the processor 310 may use the X and Y positioning of all or a substantial portion of the pixels associated with the target 520 (or a full-body detection) as a mask to extract RGB values from the original RGB image. (Recall the X and Y positioning of these pixels may be part of the detection data.). The processor 310 may then compare the spectral angles of the pixels associated with the target 520 with the preliminary reference spectral angle. The spectral angles of the pixels that are associated with the target 520 that match the preliminary reference spectral angle may define a body-part patch, which can be segmented out. To be a match, a spectral angle of an extracted pixel value may be identical to the preliminary reference spectral angle or may fall within a range that includes the preliminary reference spectral angle. The range may be defined by one or more spectral-angle thresholds.

In this example, the body-part patch is realized from the pixels associated with a torso area of the target 520. As such, the body-part patch here may be a torso patch. A pictorial representation of a torso patch 610 (with solid-line boundaries) and, hence, a body-part patch 605, is shown on the target 520 of FIG. 6. The spectral angles of the extracted pixel values that do not match (either not identical or outside the spectral-angle threshold(s)) the preliminary reference spectral angle may not be associated with the torso patch 610. In view of the accuracy of the SAM process and its application to all the pixels associated with the target 520, the torso patch 610 may be more reliable in representing the actual torso of the target 520 in comparison to the torso section 600 referenced above.

As an option, preliminary reference spectral angles may be calculated for other portions of a target 505, either as a supplement to the preliminary reference spectral angle originating from the torso section 600 or in lieu of the torso section 600. As such, this step can result in multiple body-part patches being segmented out. The pixels associated with these portions may be selected based on data from the detection fields, such as their relation to the centroid 525. Moreover, the number of pixels that are selected to serve as the basis for the preliminary reference spectral angle may be modified. For example, if the number of selected pixels is too large, a degradation in the accuracy of the preliminary reference spectral angle for defining the torso patch 610 may occur. This problem may result from some of the chosen pixels being associated with a portion of the target 520 that has a markedly different color in comparison to the (actual) torso of the target 520. In this case, the number of pixels chosen to define the torso section 600 for estimating or determining the preliminary reference spectral angle can be decreased in future color-vector-extraction steps to alleviate the degradation.

In one arrangement, the processor 310 may determine a second median RGB value from the body-part patch 605 that is segmented out, in this case, the torso patch 610. From this second median RGB value, the processor 310 may estimate or determine a second reference color vector, from which a second reference spectral angle may be obtained. An example of the application of the second reference spectral angle will be shown below. Because the second median RGB value originates from the torso patch 610, the second reference spectral angle may be a more accurate indicator of the actual color of the torso of the target 520. The second reference spectral angle may be assigned to or otherwise associated with its corresponding target, such as being attached to a track that is generated for the target 520. Optionally, second reference spectral angles may also be estimated for other body-part patches 605, if desired.

One or more second spectral-angle thresholds may also be attached to the second reference spectral angle. The second spectral-angle threshold may have the same value as that of the original spectral-angle threshold introduced above. If so, the original spectral-angle threshold and the second spectral-angle threshold may be considered a single spectral-angle threshold. These two values, however, may also be different, meaning two distinct spectral-angle thresholds may be used. In either case, the spectral-angle or second spectral-angle thresholds may be adjusted to refine the setting of the relevant body-part patches.

Notably, by comparing the spectral angles of the pixels with a reference spectral angle, color features of the targets 505 may be used to identify and accurately distinguish the targets 505 from one another. As an example, a color feature can be the color of an article of clothing or some other accessory or article worn or carried by a human. Other examples of color features include skin or hair color. As non-human objects 105 may also be tracked, color features may be colors of or associated with a non-human objects 105, such as the color of the fur of an animal. The color that serves as the basis for the tracking may be a uniform (or substantially uniform) color that results in the median RGB values. In another case, a combination of different colors may produce the median RGB values, thereby effectively being perceived as a single uniform (or substantially) uniform color.

Because color is the distinguishing characteristic in this scheme, the targets 505 may be differentiated by virtually anything associated with or attached to the targets 505. Additionally, the use of the SAM method enables discernment between colors that appear to be very similar. And because variations in brightness or illumination affect the length but not the spectral angle of a color vector, differences in the amount or intensity of light in the monitoring area 110 do not degrade the accuracy of the comparison step or the determination of the preliminary or second reference spectral angles. As such, this solution enables reliable (passive) tracking of certain objects 105, like humans, based on a characteristic (i.e., color feature) that typically does not vary over extended periods of time and is generally not the same for different targets. For example, humans normally wear the same clothes during an entire day or workday and are able to select clothing imbued with virtually any color.

As mentioned earlier, second reference spectral angles may be determined for multiple body-part patches 605. In one embodiment, second reference spectral angles may be estimated only for the torso patches 610. Focusing on the torso patch 610 is advantageous because, as noted above, humans generally wear clothing that is different in color from that worn by others, making them easier to distinguish from one another. Also, as will be shown below, the torso patch 610 may be assigned a centroid, which provides a suitable reference point from which to determine additional information about a target 505, like the orientation or posture of the target. A human torso, moreover, generally remains unobstructed by other objects 105 or background clutter, such as tables or chairs, in the monitoring area 110, in view of its relative height.

Based on the example above, once the second reference spectral angle associated with the torso patch 610 is calculated, the second reference spectral angle may be assigned to a track of the corresponding target 520. As new frames are received, the second reference spectral angle can be used to segment out a patch associated with the target 520 in these future frames. Because the TSP analysis may have shown that second reference spectral angles for the other targets 510, 515 were determined earlier, these second reference spectral angles may be employed to segment out patches of the corresponding targets 510, 515 in future frames, as well. Once the patches are segmented out and matched to the targets 505, the tracks of the corresponding targets 505 may be further constructed. To update the track, the processor 310 may conduct a redetection process, which may also be referred to as a second detection. The redetection process may employ at least some of the steps of the detection technique described previously, although there may be some differences in view of the color-based matching used here. As will be explained below, the original detection process is based on a background-subtracted segmentation image, which makes it difficult to separate overlapped (multiple) targets. As will also be shown below, the redetection process may be based on a color-vector-matched segmentation image, which can make it easier to distinguish different targets by focusing on body parts with distinct color features.

Initially, a new RGB frame may be created, and a composite binary image may be formed from it, which can be similar to the examples presented above. This new RGB frame may be formed later in time with respect to the RGB frame 500 of FIGS. 5 and 6. For this example, however, assume that all the targets have previously had their corresponding second reference spectral angles determined. (No color-vector-extraction step is necessary at this stage.) Also, assume that the tracks for the targets are in progress, meaning these targets are currently being passively tracked. As also described earlier, the detection process may be applied to the composite segmented binary image to realize detection data for the targets, and a TSP analysis may also be performed. (In this example, the TSP analysis may determine that TSPs have already been assigned to the tracks associated with the targets.)

In one arrangement, the processor 310, based on the detection data, can use the X and Y positioning of all the pixels associated with the full-body detections to obtain from the RGB frame the spectral angles of these pixels. The processor 310 can also compare a second reference spectral angle attached to one of the tracks to the spectral angles of the pixels related to the full-body detections. Groupings of pixels with spectral angles that match the second reference spectral angle can be segmented out from the full-body detections. As such, this step can identify patches of the full-body detections that are associated with a color that is similar to that for one of the targets from which the second reference spectral angle was realized. The determinations made here with respect to the matching patches with the second reference color vectors may be assigned a probability or confidence factor. Additionally, this process can be repeated for all the tracks with second reference spectral angles, which means multiple patches may be segmented out from the full-body detections. The patches that are segmented out may be referred to as patch detections. This process may enable the system to distinguish the full-body detections from one another, including full-body detections that correspond to human targets.

To perform the redetection step, the RGB pixels associated with the patch detections may be converted to binary. This process may be similar to the binary conversion stage previously presented. Namely, the groupings of RGB pixels of the patch detections may be transformed to the HSV domain, and another composite segmented binary image may be created.

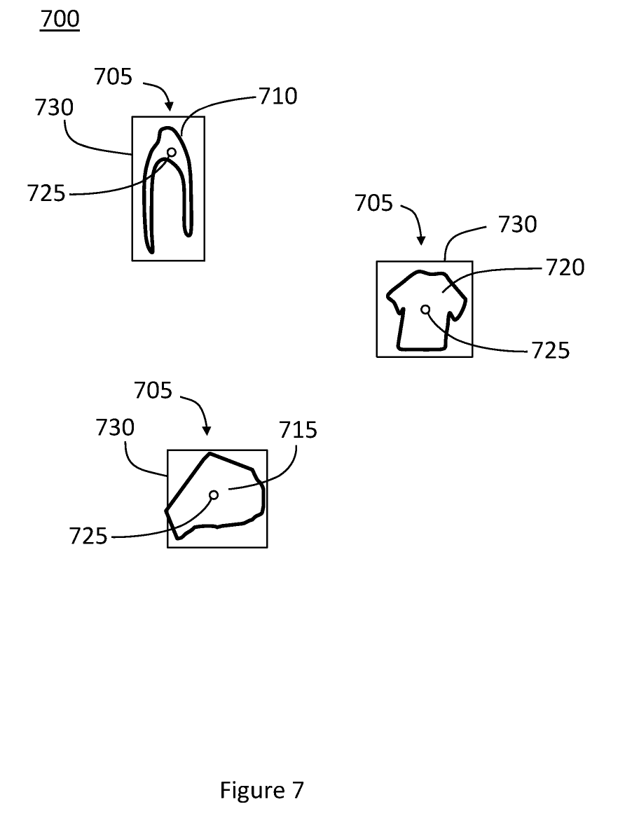

For example, referring to FIG. 7, an example of a composite segmented binary image 700 that includes three patch detections 705 (in visual form) is shown. In this example, the patch detections 705 may correspond to the torsos of targets in the monitoring area 110. The patch detections 705 may be separately referred to as patch detection 710, patch detection 715, and patch detection 720. In this example, these patch detections 710, 715, 720 may correspond (respectively) to the targets 510, 515, 520, which were presented above with respect to an earlier frame. As part of the redetection process, the processor 310, based on the composite segmented binary image 700, may calculate detection and track fields for the detection data of the patch detections 710, 715, 720. Because the tracks are in progress, the detection and track fields may be considered to be updated in this example.

In one embodiment, the detection data for the patch detections 705 may contain data similar to that for a full-body detection, although the data may be based on a smaller area, like a torso. For example, the processor 310 may determine one or more detection fields for the patch detections 705. Examples include X and Y positions for a centroid 725 and the four corners of a bounding box 730, visual representations of which are shown in FIG. 7. The X and Y positions of the centroid 725 may be used to establish the position of the corresponding target in the monitoring area 110. An X span and a Y span and a size, height-to-width (HWR) ratio, and deviation from a rectangular shape may also be calculated for the targets based on the relevant patch detection 705. The deviation from a rectangular shape may be in relation to the deviation from a rectangular shape exhibited by the relevant patch detection. Because a patch detection 705 linked to a target may be (roughly) rectangular in shape in view of the torso of the target, a significant deviation from this shape may be an indication that a patch detection is not associated with a torso and, therefore, a target. The processor 310 may also determine one or more track fields for the patch detection. Examples include the change in the X and Y positions of the centroid 725, the velocity of the target, the number of the current frame of the track, and the predicted X and Y positions of the centroid 725 in the next frame. The detection data for the patch detection is not necessarily limited to the type of data recited here.

Unlike the full-body detections, a patch detection may not need to include the X and Y positions of all its corresponding pixels. Moreover, it may not be necessary to extract the RGB values of these pixels because such a step may be obviated by the previous determination of the median color vectors.

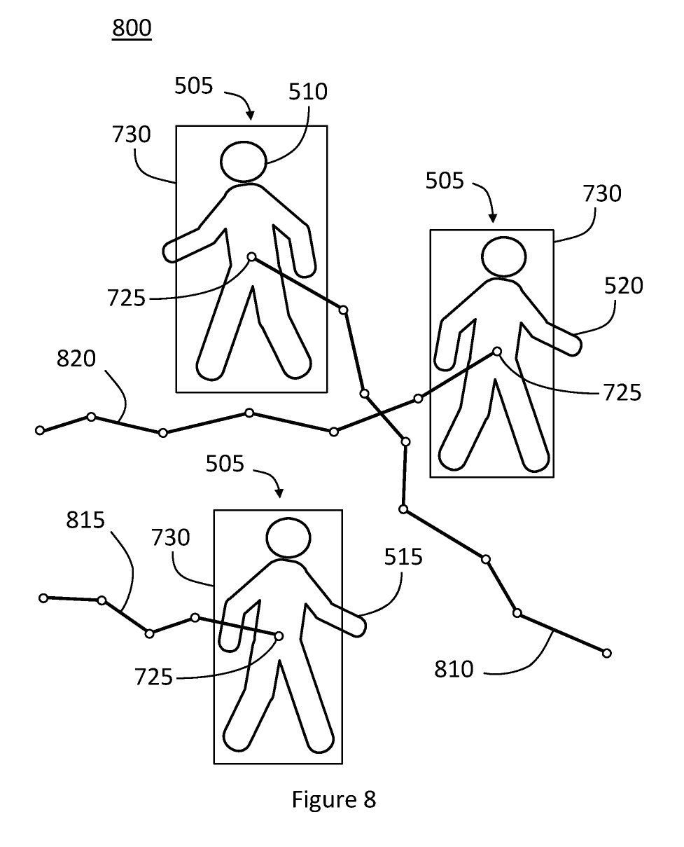

In view of the above, in one arrangement, the detection data for the patch detections 705 may be updated for each new frame for the tracks of the targets. Moreover, as part of this update, the track for a target may be further constructed. Referring to FIG. 8, another example of an RGB frame 800 is shown. The RGB frame 800, from which the composite segmented binary image 700 of FIG. 7 may have originated, is currently displaying three targets 505. In this example, the targets 505 correspond to the targets 510, 515, 520, although they have shifted in position since the frame 500. In this example, the centroids 725 and bounding boxes 730 (introduced in FIG. 7) are shown in relation to each of the targets 505. Moreover, visual representations of several tracks corresponding to the targets 505 are shown. For example, a track 810 corresponding to the target 510, a track 815 corresponding to the target 515, and a track 820 corresponding to the target 520 are illustrated. The tracks 810, 815, 820 can show the progress of their corresponding targets 510, 515, 520 in relation to a monitoring area 110 from the time the relevant TSP was assigned until the current frame, or RGB frame 800 in this example. As can be seen in this example, multiple targets can be simultaneously differentiated and passively tracked over time in a monitoring area 110 based on color features associated with the targets.

As explained earlier, not all full-body detections may necessarily correspond to targets that are intended to be tracked, as some full-body detections may arise from false detections. This principle may apply to patch detections, as well. In particular, some patch detections may be related to false detections, as opposed to targets. As an example, a false detection may be related to a color of a non-torso area of a target that substantially matches a color of a torso of a different target. Moreover, a track of a target may be interrupted or broken based on certain conditions, such as if a target walks behind a large piece of furniture. Examples of some solutions that can help overcome these problems will be presented here. Such solutions may be used to increase the probability or confidence factor of a match.

In one embodiment, the detection data from a previous frame with respect to a target may assist in filtering out false detections or otherwise improving the probabilities or confidence factors related to comparing the spectral angles of the patch detections with a second reference spectral angle. For example, the predicted positional data from the track fields, which may have been calculated for the previous frame with respect to a target, can be used to narrow the possible locations of a patch detection in the current frame related to that target. A patch detection that is positioned at or within an acceptable distance of the predicted location can be identified as the actual matching patch detection (related to the target). In contrast, patch detections that are positioned beyond this acceptable distance may be considered to have originated from false detections and can be ignored, at least with respect to the track of this particular target. In either case, the supplemental analysis can increase the probability or confidence factor of a match based on a color feature. Predicted positional data may also be helpful in reducing broken or interrupted tracks, such as from an occluded target, because positional estimates can be made for these targets, at least until they can be reacquired from color matching.

Additional detection data may be useful for this purpose, such as velocity or size. Like the example above, such data may have been determined for the previous frame. As an example, patch detections that are positioned outside an acceptable range of locations based on predicted or possible (or both) velocities may be ignored. Conversely, only patch detections inside this range may be considered to be tracking candidates. This range may be referred to as a track-gate size, and its dimensions may be based on the velocity determined for the target from the previous frame (or frames). The track-gate size may be adjustable, based on how the velocity of the target changes. Similarly, a patch detection that is outside a size threshold (in pixel count) based on the size of the actual patch detection calculated for the target for the previous frame may be designated as a false detection. Other data may be referred to for this process, as the system is not limited to these particular examples. These principles may also be applied during the initial detection process recited above to help reduce the effects of false detections during that stage. More information on these concepts can be found in “Robust Image-Domain Target Tracking and Recognition Process under Heavy Urban Background Clutter Conditions,” Hai-Wen Chen and Dennis Braunreiter, Acquisition, Tracking, Pointing, and Laser System Technologies XXIII, Proc. of SPIE, Vol. 7338, 73380M, 2009, which is incorporated herein by reference.

The data used to increase the accuracy of the redetection process based on color features may be referred to as redetection-assistance factors. Based on the results provided by the redetection-assistance factors, the confidence factor of the redetection may be increased, which can lead to more robust passive tracking and fewer false detections. In some cases, the results from this evaluation may contradict the matching based on color. If so, the color match may or may not be overridden. Further, the processor 310 may use redetection-assistance factors for all patch detections or may rely on them selectively, such as only executing the evaluations if the initial match based solely on color does not produce a confidence factor that meets or exceeds a confidence threshold. Weights may be selectively applied to the redetection-assistance factors based on past success in the redetection process, and these weights may be adjusted (if necessary) in the future.

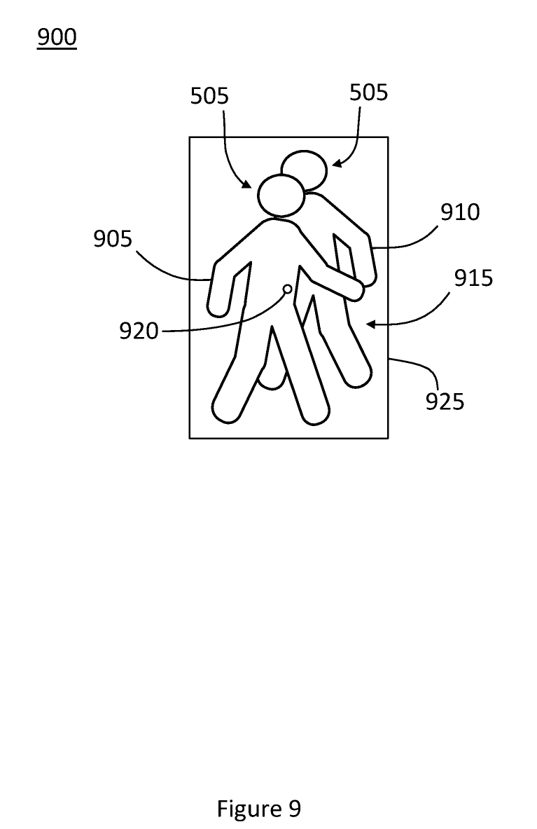

An example of how the solutions described herein present an advantage over pre-existing systems will now be presented. Referring to FIG. 9, an example of an RGB frame 900 that depicts (in visual form) two targets 505, a first target 905 and a second target 910, in a monitoring area 110 is shown. In this example, the targets 505 are positioned close together, with the first target 905 in front of the second target 910 (from the perspective of the camera 300). A conventional tracking system would be unable to distinguish the first target 905 from the second target 910, and as such, the two targets 505 would produce a single full-body detection, or a merged full-body detection 915 (shown in visual form here). The system would then determine a common centroid 920 and a common bounding box 925 for the merged full-body detection 915, as reflected in FIG. 9. This occurrence will most certainly interrupt or break the tracking of either the first target 905, the second target 910, or both or may cause the system to assign an existing track to the wrong target 505.

In such a circumstance, the systems and methods described herein, however, can distinguish the targets 505 from one another based on their color features. As explained above, the color features may relate to the color of an article of clothing (or other things, like skin, hair, accessories, etc.) associated with a target 505. Thus, the tracking of the targets 505, even when they are positioned next to each other, may continue uninterrupted. The systems and method presented herein also reduce the number of false detections during passive tracking of the targets 505.

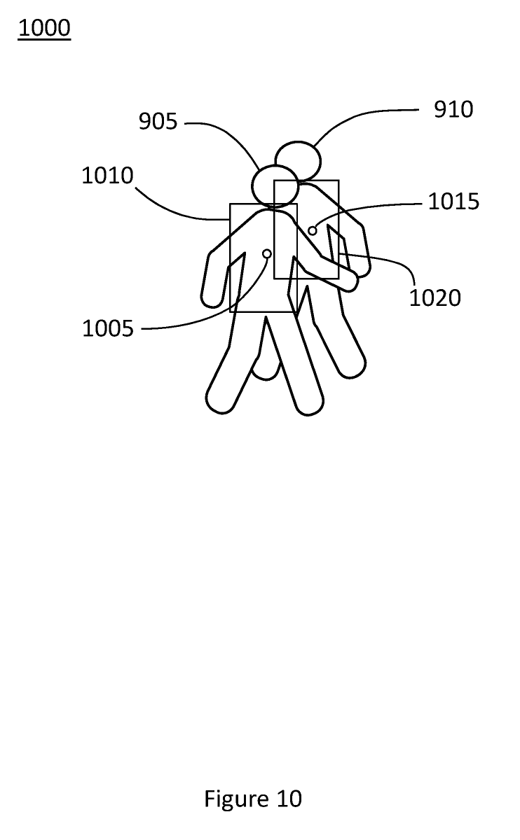

Referring to FIG. 10, an example of an RGB frame 1000 that illustrates the first target 905 and the second target 910 is shown. In this example, the first target 905 and the second target 910 are shown in the same positions they occupied in the frame 900 of FIG. 9. Here, however, the system has calculated a centroid 1005 and a bounding box 1010 for the first target 905 and a separate centroid 1015 and bounding box 1020 for the second target 910. (The centroids 1005, 1015 and bounding boxes 1010, 1020 here may be based on patch detections.) As such, the problem of merged detections does not interfere with passive tracking of either the first target 905 or the second target 910. Accordingly, robust tracking of multiple targets in a monitoring area 110 at the same time can be realized. Moreover, these techniques are scalable, as large numbers of targets 505 in the area 110 may be simultaneously tracked using them.

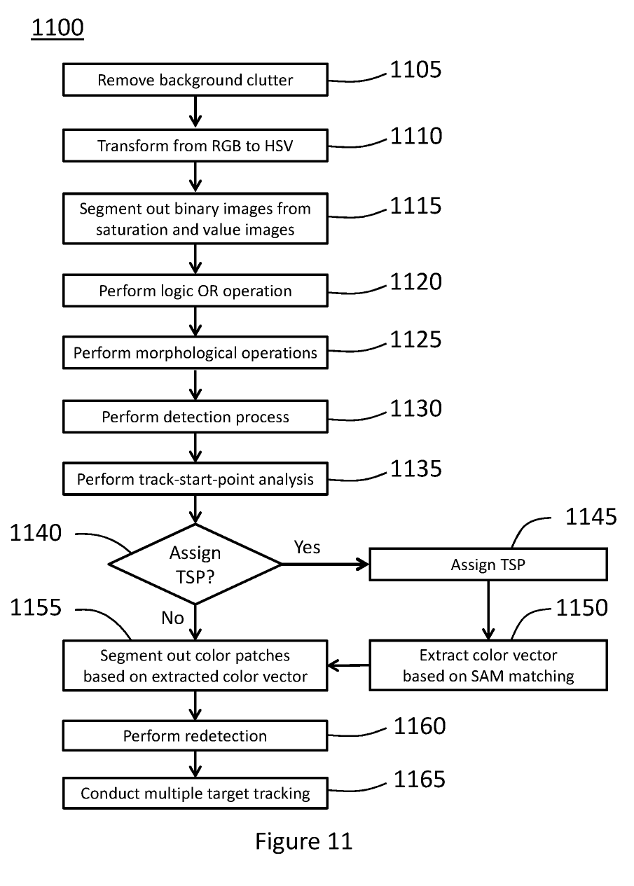

Referring to FIG. 11, a flow chart 1100 that presents a summary of an example of a procedure for passively tracking targets based on color features is shown. The flow chart 1100 is intended to summarize one possible implementation of the techniques described herein. As such, additional steps may be added to or they may be dropped from the flow presented here. Moreover, the steps depicted here are not necessarily limited to this particular sequence, as they may be in a different chronological order.

At step 1105, a background subtraction process may be performed in which a current image frame is subtracted by the background image to remove static background clutter. At step 1110, an RGB to HSV transformation may be conducted in which the image is transformed from RGB to the HSV domain. A foreground-object segmentation process may then be carried out, as shown at step 1115. Here, binary images can be segmented out from the saturation and value images based on median and constant-threshold values. At step 1120, a logic OR operation between the saturation and value images can be executed to form a new binary image, and at step 1125, morphological operations, including dilation, erosion, and opening processes, can be conducted to remove false detections, such as small false foreground patches. A detection process can then be performed in which a full-body detection is done on the binary segmentation image, as shown at step 1130. This step can result in certain calculated features or fields, such as centroids, X and Y spans, pixel sizes, length-to-width ratio, and extent deviation, and RGB pixel values related to the detections can be extracted, as needed.

At step 1135, a track-start-point (TSP) analysis can be performed. At step 1140, if the TSP analysis shows a TSP should be assigned to a full-body detection, the flow can proceed to step 1145, where the TSP can be assigned to the full-body detection, which designates the detection as the track's first frame. From there, at step 1150, a SAM-matching process can be performed to extract the color vector of the torso body part from the RGB pixel values of the full-body detection assigned as part of the TSP analysis. The flow can continue to step 1155. Moreover, moving back to step 1140, if the TSP analysis shows that no TSP should be assigned to the full-body detection, the flow from there can resume at step 1155. At step 1155, a SAM-matching process for torso-patch segmentation can be conducted in which the extracted color vector can be used to segment out similar color patches (related to the torso body part) from the images of future-time frames with a SAM process.

At step 1160, a redetection (or second detection) process can be performed in which a detection process is executed based on the new segmentation binary image. Finally, at step 1165, multiple human tracking can be conducted in which multiple target tracking can be done with respect to the human targets.

Although the solutions described herein primarily focus on indoor settings, the system may be capable of operating in areas that are not enclosed or sheltered. For example, the system may be positioned in areas that are exposed to the environment, such as open locations in amusement parks, zoos, nature preserves, parking lots, docks, or stadiums. Environmental features, like sunlight patterns, foliage, snow accumulations, or water pooling, may be integrated into any number of relevant reference frames, in accordance with previous descriptions, and eliminated as clutter.

This technique of detecting multiple targets in the incoming frames, assigning TSPs as necessary, and tracking the targets based on comparing (reference) color vectors with portions associated with the targets presents a robust solution to passively tracking humans or other objects. Moreover, because this solution is geared towards a visible-light camera, the techniques and processes described herein may be implemented by simply retrofitting existing camera systems. As such, this system provides numerous possibilities for reliably passively tracking objects without requiring significant investments for its implementation.

The flowcharts (if any) and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and or processes described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein.

Furthermore, arrangements described herein may take the form of a computer program product embodied in one or more computer-readable media having computer-readable-program code embodied (e.g., stored) thereon. Any combination of one or more computer-readable media may be utilized. The computer-readable medium may be a computer-readable signal medium or a computer-readable storage medium. The phrase “computer-readable storage medium” is defined as a non-transitory, hardware-based storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Program code embodied on a computer-readable storage medium may be transmitted using any appropriate systems and techniques, including but not limited to wireless, wireline, optical fiber, cable, RF, etc., or any suitable combination of the foregoing. Computer program code for carrying out operations for aspects of the present arrangements may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects herein can be embodied in other forms without departing from the spirit or essential attributes thereof. Accordingly, reference should be made to the following claims, rather than to the foregoing specification, as indicating the scope hereof.

1. A camera for passively tracking a human, comprising:
an image-sensor circuit configured to generate a frame of a monitoring area; and
a processor configured to:
receive the frame from the image-sensor circuit; and
track a first target that is part of the frame based on a color feature of the first target, wherein the processor, as part of its tracking the first target, is further configured to:
wherein the first target is a new target that has entered the monitoring area and based on being a new target, generate a reference spectral angle from the first target;
compare the reference spectral angle to spectral angles of color pixels associated with the first target;
determine that the spectral angles of at least a portion of the color pixels associated with the first target match the reference spectral angle based on a spectral-angle threshold of the reference spectral angle; and
segment out a patch detection corresponding to the first target that is defined by the color pixels with spectral angles that match the reference spectral angle based on the spectral-angle threshold.

2. The camera of claim 1, wherein the camera is a red-green-blue (RGB) camera that is configured to operate in at least three spectral bands corresponding to the colors red, green, and blue.

3. The camera of claim 1, wherein the first target is a human and the color feature of the first target is a color of an article of clothing worn by the human while in the monitoring area.

4. The camera of claim 1, wherein the processor, as part of its tracking the first target, is further configured to update a position of the first target in the monitoring area.

5. The camera of claim 1, wherein the patch detection that is segmented out is related to a torso of the first target.

6. The camera of claim 1, wherein the processor is further configured to track a second target that is part of the frame based on a color feature of the second target and wherein the processor, as part of its tracking of the first target and the second target, is further configured to:
perform a track-start-point (TSP) analysis on the first target and the second target;
as part of the TSP analysis, determine the second target is a new target that requires assignment of a TSP; and
assign a TSP to the second target to enable its tracking of the second target to begin.

7. The camera of claim 6, wherein the processor is further configured to, as part of its determination that the second target is a new target, analyze positional and motion data of the second target with respect to a layout of the monitoring area.

8. The camera of claim 6, wherein the processor is further configured to, following the TSP analysis, initiate a color-vector-extraction process with respect to the second target to determine a median color vector, wherein the median color vector comprises a second reference spectral angle for the second target.

9. The camera of claim 8, wherein the median color vector is determined from a median red-green-blue (RGB) value from color pixels associated with the second target.

10. A method for passively tracking multiple humans, comprising:
generating a first detection associated with color pixels, wherein the first detection represents a first human in a monitoring area;
generating a second detection associated with color pixels, wherein the second detection represents a second human who has entered the monitoring area and the second human is in the monitoring area at the same time as the first human;
determining the second detection is a new detection in the monitoring area;
based on determining, the second detection is a new detection in the monitoring area, generating a reference spectral angle from the second detection;
distinguishing the first detection from the second detection by matching spectral angles of the color pixels associated with the first detection with a reference spectral angle originating from the first detection and matching spectral angles of the color pixels of the second detection with the reference spectral angle originating from the second detection; and
based on distinguishing the first detection from the second detection, simultaneously passively tracking the first human and the second human.

11. The method of claim 10, further comprising:
generating a third detection associated with color pixels, wherein the third detection represents a third human in the monitoring area and the third human is in the monitoring area at the same time as the first human and the second human;
determining the third detection is a new detection; and
based on determining the third detection is a new detection, assigning a track-start-point (TSP) to the third detection to enable passive tracking of the third human to begin.

12. The method of claim 11, wherein the first detection, second detection, and third detection are part of a frame and the frame further comprises one or more false detections, wherein the method further comprises filtering the false detections as part of distinguishing the first detection from the second detection.

13. The method of claim 10, wherein the color pixels associated with the first detection correspond to a color feature of the first human and the color pixels associated with the second detection correspond to a color feature of the second human.

14. The method of claim 13; further comprising:
producing a first torso-patch detection from matching the spectral angles of the color pixels associated with the first detection with the reference spectral angle of the first detection; and
producing a second torso-patch detection from matching the spectral angles of the color pixels associated with the second detection with the reference spectral angle of the second detection.

15. The method of claim 14, wherein simultaneously passively tracking the first human and the second human comprises determining a centroid position for the first torso-patch detection and the second torso-patch detection.

16. The method of claim 10, wherein the color pixels associated with the first detection and the color pixels associated with the second detection are part of a frame produced by a red-green-blue camera.

17. A method of tracking humans by a color feature, comprising:
receiving a frame of a monitoring area in which at least two humans are simultaneously located in the monitoring area;
generating digital representations corresponding to the humans in the monitoring area;
determining one of the digital representations is new to the monitoring area and one of the digital representations is already part of the monitoring area and has had a reference spectral angle previously generated;
based on determining the one of the digital representations is new to the monitoring area, generating a reference spectral angle from the new digital representation;
distinguishing the digital representations from one another based on color features associated with the humans by comparing spectral angles of color pixels of the digital representations with the corresponding, reference spectral angles; and
determining positions of the humans as part of passively tracking the humans, wherein determining the positions of the humans is facilitated by distinguishing the digital representations from one another.

18. The method of claim 17, wherein receiving the frame of the monitoring area further comprises receiving the frame from a camera designed to operate in a red-light spectral band, a green-light spectral band; and a blue-light spectral band.

19. The method of claim 17, further comprising performing a track-start-point (TSP) analysis to determine whether to assign a TSP to one or more of the digital representations.

20. The method of claim 17, wherein the color features associated with the humans are colors of articles of clothing worn by the humans while in the monitoring area.
